(19) United States
(12) Patent Application Publication
(10) Pub. No.: US 2008/0047310 A1
(43) Pub. Date: Feb. 28, 2008

(54) Lock core operable by either of two keys

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/603,029

(22) Filed: Nov. 22, 2006

(30) Foreign Application Priority Data
Aug. 24, 2006 (TW) 095131202

(51) Int. Cl. E05B 35/08

(52) U.S. Cl. 70/337

(57) ABSTRACT

A lock core comprises a cylinder and a shaft. The cylinder defines a chamber. The shaft is rotationally inserted in the chamber of the cylinder and defines a keyhole which comprises a first slot, a second slot in communication with the first slot, and a third slot in communication with the first slot. The first and the second slots can receive a first key. The first and the third slots can receive a second key. Accordingly, the lock core can be operated by either the first key or the second key.

### BACKGROUND OF INVENTION

1. Field of Invention

This invention relates in general to lock cores and more particularly to improvements in cylinder tumbler lock core which is installed in a lock and operable by either one of two keys.

2. Related Prior Art

A conventional lock comprises a lock core which can be rotated for locking and unlocking by only a key.

In order to satisfy the need for the checking by a custom inspector and to ensure that the lock won't be unlocked by others, a lock is normally arranged to include two lock cores. One of the lock cores is a combination lock core while the other is a key-operated lock core. The combination lock core can only be unlocked by a user who enters a correct code. The key-operated lock core can only be operated by the custom inspector, who holds a specific key. Examples can be found in the U.S. Pat. Nos. 7,007,521 B1 and 6,877,345 B1.

However, the lock with two lock cores includes a complicated and bulky structure and entails a high cost. More particularly, the user has to remember the correct code so as to unlock the lock. The user would have trouble unlocking the lock should he or she forget the code.

What is desired, therefore, is a lock which is not subject to any of the foregoing disadvantages.

### SUMMARY OF INVENTION

The primary object of this invention is therefore to provide a lock core mechanism operable by either a first key or a second key.

According to the present invention, a lock core comprises a cylinder and a shaft. The cylinder defines a chamber. The shaft is rotationally inserted in the chamber of the cylinder. The shaft defines a keyhole which includes a first slot, a second slot in communication with the first slot and a third slot in communication with the first slot. The first and the second slots can receive a first key. The first and the third slots can receive a second key.

Further benefits and advantages of the present invention will become apparent from the following descriptions taken in conjunction with the accompanying drawings.

### BRIEF DESCRIPTION OF DRAWINGS

The invention will now be elucidated by reference to the following description and accompanying drawings where:

FIG. 1 is a perspective view of a lock core and keys according to a first embodiment of the present invention;

FIG. 2 is a front view of the lock core of FIG. 1, illustrating a first key inserted in a keyhole;

FIG. 3 is similar to FIG. 2 except illustrating a second key inserted in the keyhole;

FIG. 4 is an exploded view of the lock core shown in FIG. 1;

FIG. 5 is a cross-sectional view of the lock core shown in FIG. 1;

FIG. 6 is a cross section of the lock core taken along a line A-A in FIG. 5;

FIG. 7 is a cross-sectional view of the lock core while receiving the first key shown in FIG. 1;

FIG. 8 is a cross section of the lock core and the first key taken along a line B-B in FIG. 7;

FIG. 9 is a cross-sectional view of the lock core while receiving the second key shown in FIG. 1; and

FIG. 10 is a cross section of the lock core and the second key taken along a line C-C in FIG. 9;

FIG. 11 shows another example of the keyhole according to the invention;

FIG. 12 is a perspective view of a lock, showing the lock core of the first embodiment is assembled in the lock;

FIG. 13 is a perspective view of another lock comprising a lock core according to a second embodiment of the present invention.

### DETAILED DESCRIPTION OF EMBODIMENTS

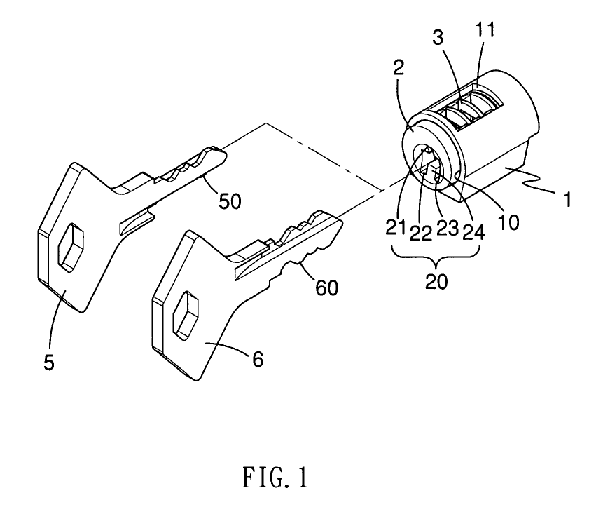

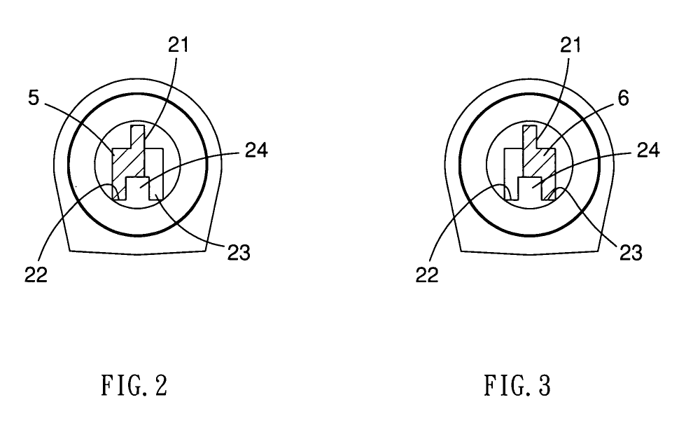

With reference to FIGS. 1 to 3, description will be given of a lock core mechanism according to a first embodiment of this invention.

The lock core comprises a cylinder 1 and a shaft 2. The cylinder 1 defines a chamber 10. The shaft 2 is rotationally inserted in the chamber 10 of the cylinder 1. The shaft 2 defines a keyhole 20 which includes a first slot 21, a second slot 22 in communication with the first slot 21, and a third slot 23 in communication with the first slot 21. The first and the second slots 21 and 22 can receive a first key 5. The first and the third slots 21 and 23 can receive a second key 6.

Thus, the keyhole 20 can receive either of the two keys 5 and 6 so that the shaft 2 can be driven by either of the keys.

The shaft 2 comprises a block 24 disposed between the second and the third slots 22 and 23 so that a selected one of the first and the second keys 5 and 6 can abut the block 24 to rotate the shaft 2.

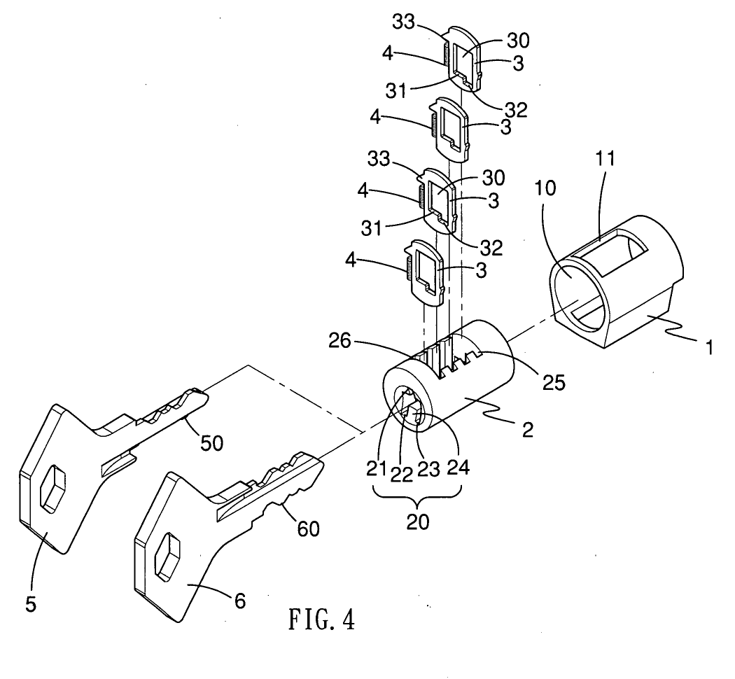

Referring to FIG. 4, the lock core comprises a plurality of driving members 3 disposed between the shaft 2 and the cylinder 1, so that either the first key 5 or the second key 6 can be inserted in the keyhole 20 for controlling the driving members 3 for rotating the shaft 2 within the cylinder 1. The driving members 3 may be a plurality of plates (described hereinafter) or a plurality of pin-tumbler assemblies each comprising an upper tumbler pin, a lower tumbler pin and a coil spring.

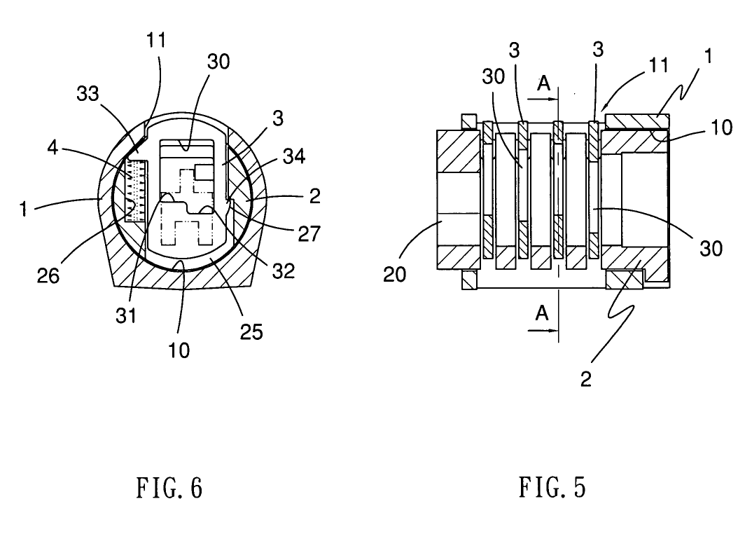

As further shown in FIGS. 4 to 6, the lock core mechanism comprises four springs 4. Further, the cylinder 1 comprises a wall defining an opening 11 in communication with the chamber 10. The shaft 2 defines a plurality of channels 25 and rooms 26. The channels 25 run through the shaft 2 on either side. The channels 25 are in communication with the keyhole 20. However, each room 26 is proximate to a related channel 25. The rooms 36 are not defined through the shaft 2.

Being inserted in each channel 25, each of the driving members 3 comprises an aperture 30 with a first wall and a second wall. A first face 31 and a second face 32 are formed on the first wall of the aperture 30. A protrusion 33 is formed on the second wall of the aperture 30.

Each of the springs 4 is inserted in each room 26, with a top abutting against the protrusion 33 of each driving member 3 so that an end of each driving member 3 is embedded in the opening 11 of the cylinder 1.

As shown in FIG. 6, the shaft 2 defines a plurality of recesses 27 in walls of the channels 25 opposite to the rooms 26, and each of the driving members 3 comprises a knob 34 formed thereon opposite to the protrusion 33, and the knob 34 is embedded in a related one of the recesses 27 for avoiding the driving members 3 bouncing off the springs 4 and the channels 25.

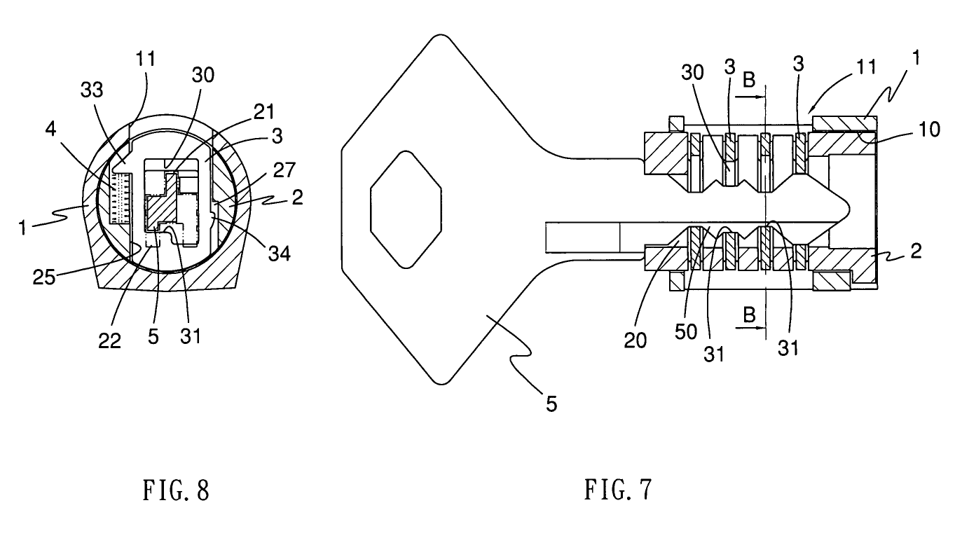

Referring to FIGS. 7 to 8, the first key 5 comprises a plurality of teeth 50. When the first key 5 is inserted in the first slot 21 and the second slot 22, the teeth 50 press against the first faces 31 of the driving members 3 so that the driving members 3 are completely retracted into the channels 25 of the shaft 2 and separated from the opening 11 of the cylinder 1. Thus, the first key 5 can be operated to drive the shaft 2 for rotating within the cylinder 1.

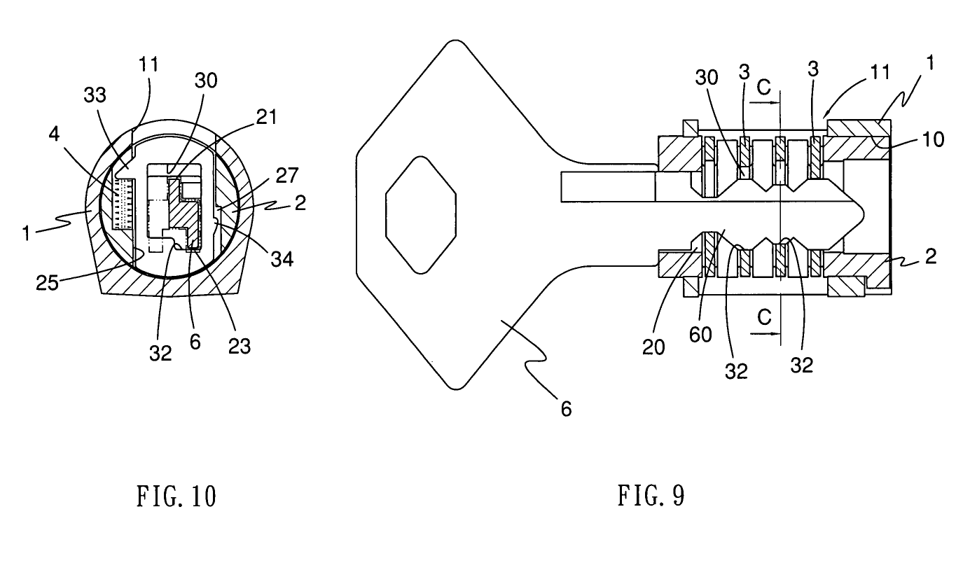

Referring to FIGS. 9 to 10, the second key 6 comprises a plurality of teeth 60. While the second key 6 is inserted in the first slot 21 and the third slots 23, the teeth 60 press against the second faces 32 of the driving members 3 so that the driving members 3 are completely retracted into the channels 25 of the shaft 2 and separated from the opening 11 of the cylinder 1. Thus, the second key 6 can be operated to drive the shaft 2 for rotating within the cylinder 1.

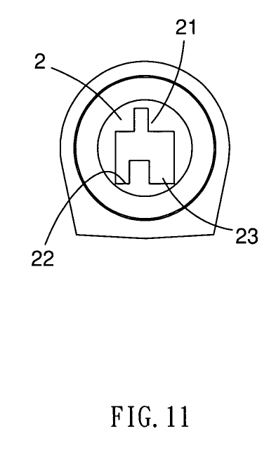

As shown in FIG. 11, the first, the second and the third slots may include different dimensions and features.

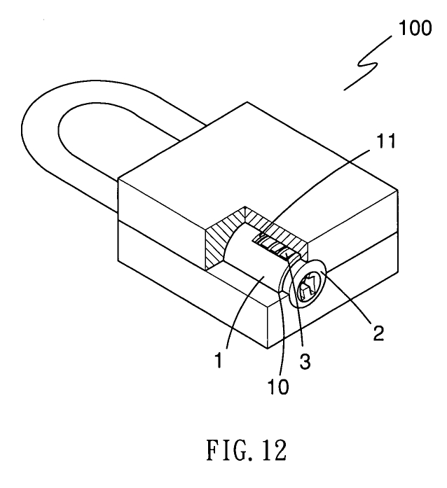

FIG. 12 shows that the lock core of the first embodiment is suitable for being assembled in a lock 100, such as a padlock or the like, for locking and unlocking the same.

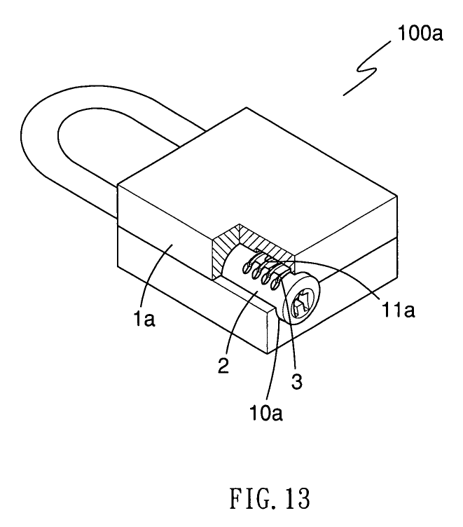

Referring to FIG. 13, a lock core according to a second embodiment of the present invention is similar to the lock core of the first embodiment shown in FIG. 12 except several things. Firstly, the cylinder 1, along with the chamber 10 as shown in FIG. 12, is omitted. Instead, the lock core according to the second embodiment includes a shell 1a defining a compartment 10a for receiving the shaft 2. Secondly, however, the lock 100a of FIG. 13 defines a notch 11a in an internal side of the shell 1a thereof for disposing the driving members between the shaft 2 and the shell 1a instead for the same purpose. Thus, the driving members in the second embodiment can function in the same way with the one in the first embodiment.

As noted above, the lock core according to the present invention can be unlocked by either the first key 5 kept by a custom inspector or the second key 6 held by a user. The custom inspector can open a luggage for inspection without damaging the lock. Accordingly, the lock core of the present invention fulfills the requirement of security inspection and is advantageous for not requiring the user to remember any code. More particularly, the size of the lock is considerably small.

Numerous characteristics and advantages of the invention have been set forth in the foregoing description. The disclosure, however, is illustrative only, and changes may be made in detail within the principle of the invention, to the full extent indicated by the broad general meaning of the terms in which the appended claims are expressed.

1. A lock core comprising:
a cylinder defining a chamber; and
a shaft being rotationally disposed in the chamber of the cylinder and defining a keyhole which comprises a first slot, a second slot in communication with the first slot, and a third slot in communication with the first slot, wherein the first and the second slots are provided for co-receiving a first key, and the first and the third slots are provided for co-receiving a second key.

2. The lock core of claim 1, wherein the shaft comprises a block disposed between the second and the third slots so that a selected one of the first and the second keys can abut the block to rotate the shaft.

3. The lock core of claim 1 comprising a plurality of driving members disposed between the shaft and the cylinder, and a selected one of the first and the second keys can be inserted in the keyhole for controlling the driving members for rotating the shaft within the cylinder.

4. The lock core of claim 2 comprising a plurality of driving members disposed between the shaft and the cylinder, and either the first key or the second key can be inserted in the keyhole for controlling the driving members for rotating the shaft within the cylinder.

5. The lock core of claim 4 comprising a plurality of springs, wherein the cylinder comprises a wall defining an opening in communication with the chamber, and the shaft defines a plurality of channels for receiving the driving members and a plurality of rooms in communication with the channels, and the springs are installed in the rooms for pushing the driving members so that each of the driving members comprises an end embedded in the opening of the cylinder.

6. The lock core of claim 5, wherein each of the driving members defines an aperture with a wall that comprises a first face and a second face, and the first and the second faces can be driven by the first and the second keys respectively so that the end of each of the driving members is retracted into the shaft.

7. The lock core of claim 6, wherein each of the driving members comprises a protrusion formed thereon for contact with a related one of the springs.

8. The lock core of claim 7, wherein the shaft further defines a plurality of recesses in walls of the channels opposite to the rooms, and each of the driving members comprises a knob formed thereon opposite to the protrusion, and the knob is embedded in a related one of the recesses for avoiding the driving members bouncing off the springs.

9-13. (canceled)

14. A lock comprising:
a shell;
a lock core disposed in the shell and including a shaft; the shaft defining a keyhole which includes a first slot, a second slot in communication with the first slot, and a third slot in communication with the first slot, wherein the first and the second slots are provided for co-receiving a first key, and the first and the third slots are provided for co-receiving a second key.

15. A lock core including a shaft which defines a keyhole; the key hole including a first slot, a second slot in communication with the first slot, and a third slot in communication with the first slot, wherein the first and the second slots are provided for co-receiving a first key, and the first and the third slots are provided for co-receiving a second key.
